(19) United States
(12) Patent Application Publication
(10) Pub. No.: US 2025/0222708 A1
(43) Pub. Date: Jul. 10, 2025

(54) SYSTEM AND METHOD FOR MEASURING PRIMER PARAMETERS IN INKJET PRINTERS

(71) Applicant: Xerox Corporation, Norwalk, CT (US)

(72) Inventors: Palghat S. Ramesh, Pittsford, NY (US); Seemit Praharaj, Webster, NY (US); Varun Sambhy, Pittsford, NY (US); Peter M. Gulvin, Webster, NY (US); Jason M. LeFevre, Penfield, NY (US); Anthony S. Condello, Webster, NY (US); Jorge A. Alvarez, Webster, NY (US); Douglas K. Herrmann, Webster, NY (US); Christine Steurrys, Williamson, NY (US); Mark Petropoulos, Webster, NY (US)

(21) Appl. No.: 18/408,280

(22) Filed: Jan. 9, 2024

(51) Int. Cl. B41J 29/393; B41J 2/21; B41J 11/00; B65H 5/06

(52) U.S. Cl. CPC B41J 29/393; B41J 2/2114; B41J 11/007; B65H 5/062; B41J 2029/3935; B65H 2511/13; B65H 2553/22

(57) ABSTRACT

An inkjet printer includes a primer applicator to apply primer to media before the media is printed and includes a plurality of eddy current sensors to identify a thickness of the primer on the media. The identified thickness is compared to a range of acceptable primer thicknesses. One end of the range of acceptable thicknesses corresponds to a thickness that is too thin to enable deinking of the printed media and the other end of the range of acceptable thicknesses corresponds to a thickness that is too thick to enable sufficient drying to fix the ink image to the media. In one embodiment, the primer is applied using a printhead that eject drops of primer onto the media.

### TECHNICAL FIELD

This disclosure relates generally to devices that produce ink images on media, and more particularly, to the application of primers to media in such printers prior to printing the media.

### BACKGROUND

Inkjet imaging devices, also known as inkjet printers, eject liquid ink from printheads to form images on an image receiving surface. The printheads include a plurality of inkjets that are arranged in an array. Each inkjet has a thermal or piezoelectric actuator that is coupled to a printhead controller. The printhead controller generates firing signals that correspond to digital data content that define the images. The actuators in the printheads respond to the firing signals by expanding into an ink chamber fluidly connected to a nozzle to eject ink drops from the nozzle onto an image receiving surface to form an ink image that corresponds to the digital image content used to generate the firing signals. The image receiving surface is usually a continuous web of media material or a series of media sheets.

Inkjet printers used for producing color images typically include multiple printhead modules. Each printhead module includes one or more printheads that typically eject a single color of ink. In a typical inkjet color printer, four printhead modules are positioned in a process direction with each printhead module ejecting a different color of ink. The four ink colors most frequently used are cyan, magenta, yellow, and black. The common nomenclature for such printers is CMYK color printers. Some CMYK color printers have two printhead modules that print each color of ink. The printhead modules that print the same color of ink are offset from each other by one-half of the distance between adjacent inkjets in the cross-process direction to double the number of pixels per inch to increase the density of a line of the color of ink ejected by the printheads in the two modules. As used in this document, the term “process direction” means the direction of movement of the image receiving surface as it passes the printheads in the printer and the term “cross-process direction” means a direction that is perpendicular to the process direction in the plane of the image receiving surface.

The image quality of aqueous ink images printed onto various types of media varies according to the type of media being printed. Image quality is typically excellent when the aqueous ink is printed onto offset coated, non-glossy media because the ink remains on top of the coating. Aqueous ink printing onto uncoated, porous media, however, produces washed out looking images because the inks are absorbed into the fibers of the paper. To avoid this consequence, coatings are applied to porous media to reduce the absorption of the inks into the media. As used in this document, the term “primer” means coatings that are applied to media to improve the image quality of the ink images over that which is achieved without the coatings. Primers reduce the interaction of the inks with the media since the primer is interposed between the media and the inks. Because the ink image is fixed to the primer layer rather than the media, the ink image can be more easily removed. The ease of ink image removal from media is a significant factor in recycling printed media.

When primer is applied to coated media, the primer mostly remains on top of the media surface. When primer is applied to uncoated media, however, it is absorbed into the fibers of the media. Therefore the thickness and amount of primer applied to media prior to printing depends on the type of media. That is, uncoated media likely needs more primer than coated media. Because primers are water-based, the use of a primer on uncoated media puts an additional load on the image dryers in a printer since more water needs to be evaporated to fix the ink images on the primer. Thus, the temperature in the image dryer or the speed of the printed media through the image dryer or both need to be adjusted to handle this additional load.

An additional issue arises with the use of primers on media because primers are typically clear. Thus, they are difficult to detect with optical image generators. Consequently, measurements of the amount of primer on media are hard to obtain and may not be accurate so regulating the application of primers to media, especially uncoated media, can be inefficient. Thus, inkjet printers would benefit from being able to treat media with primers effectively and efficiently.

### SUMMARY

A new color inkjet printer is configured to treat media with primers effectively and efficiently. The color inkjet printer includes a primer applicator configured to apply primer to media as the media passes the primer applicator; a sensor configured to generate electrical signals corresponding to a thickness of the primer applied to the media; and a controller operatively connected to the primer applicator and the sensor. The controller is configured to identify a range of primer thicknesses for the media to which the primer is being applied; identify a thickness of the primer on the media; compare the identified thickness to the identified range of primer thicknesses; and adjust operation of the primer applicator in response to the identified thickness being out of the identified range of primer thicknesses.

A new method of operating a color inkjet printer treats media with primers effectively and efficiently. The method includes identifying a range of primer thicknesses for media to which a primer is to be applied by a primer applicator; identifying a thickness of primer applied to the media; comparing the identified thickness to the identified range of primer thicknesses; and adjusting operation of the primer applicator in response to the identified thickness being out of the identified range of primer thicknesses.

### BRIEF DESCRIPTION OF THE DRAWINGS

The foregoing aspects and other features of a color inkjet printer and color inkjet printer operational method that is able to treat media with primers effectively and efficiently are explained in the following description, taken in connection with the accompanying drawings.

FIG. 1 is a schematic drawing of a color inkjet printer that is able to treat media with primers effectively and efficiently.

FIG. 2 depicts the operation of an eddy current sensor used in the printer of FIG. 1.

FIG. 3 shows the output signal of the sensor shown in FIG. 2 as media bearing primer passes the sensor.

FIG. 4 is a flow diagram for operating the inkjet printer of FIG. 1.

### DETAILED DESCRIPTION

For a general understanding of the environment for the printer and the printer operational method disclosed herein as well as the details for the printer and the printer operational method, reference is made to the drawings. In the drawings, like reference numerals have been used throughout to designate like elements. As used herein, the word “printer” encompasses any apparatus that ejects ink drops onto different types of media to form ink images.

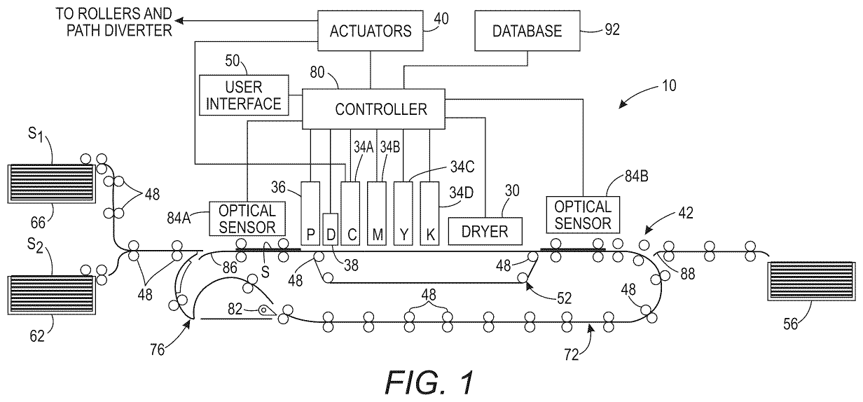

FIG. 1 depicts a high-speed color inkjet printer 10 that uses primer measuring device to identify accurately the amount of primer applied to media in the printer to enable media to be treated with primers effectively and efficiently. As illustrated, the printer 10 is a printer that directly forms an ink image on a surface of a media sheet stripped from one of the supplies of media sheets S₁ or S₂ and the sheets S are moved through the printer 10 by the controller 80 operating one or more of the actuators 40 that are operatively connected to rollers or to at least one driving roller of conveyor 52 that comprise a portion of the media transport 42 that passes through the print zone of the printer. In one embodiment, each printhead module has only one printhead that has a width that corresponds to a width of the widest media in the cross-process direction that can be printed by the printer. In other embodiments, the printhead modules have a plurality of printheads with each printhead having a width that is less than a width of the widest media in the cross-process direction that the printer can print. In these modules, the printheads are arranged in an array of staggered printheads or a linear array of printheads that abut one another to enable media wider than a single printhead to be printed. Additionally, the printheads within a module or between modules can also be interlaced so the density of the drops ejected by the printheads in the cross-process direction can be greater than the smallest spacing between the inkjets in a printhead in the cross-process direction. Although printer 10 is depicted with only two supplies of media sheets, the printer can be configured with three or more sheet supplies, each containing a different type or size of media.

With further reference to FIG. 1, the printed image exits the print zone of printer 10 and passes under an image dryer 30 after the ink image is printed on a sheet S. As used in this document, the term “print zone” means an area of a media transport opposite the printheads of an inkjet printer. The image dryer 30 can include an infrared heater, a heated air blower, air returns, or combinations of these components to heat the ink image and at least partially fix an ink image to the sheet S. An infrared heater applies infrared heat to the printed image on the surface of the sheet S to evaporate water or solvent in the ink. The heated air blower directs heated air using a fan or other pressurized source of air over the ink to supplement the evaporation of the water or solvent from the ink. The air is then collected and evacuated by air returns to reduce the interference of the dryer air flow with other components in the printer.

Prior to reaching the print zone, the media passes beneath a primer application module 36. The primer application module 36 includes one or more printheads configured as described previously. These printheads ejected drops of primer onto the media prior to the media being printed by the printhead modules 34A, 34B, 34C, and 34D. The amount and thickness of primer applied to the media is measured by a detector 38. The signal generated by the detector 38 is provided to the controller 80. The controller 80 is configured with programmed instructions stored in non-transitory, computer readable media that when executed cause the controller to identify the amount and thickness of primer on the media and adjust the operation of the primer application module 36 to apply the primer efficiently for the type of media being printed. The operation of the detector 38 is described in more detail below.

A return path 72 is provided to receive a sheet from the media transport 42 after a substrate has been completely or partially printed and passed through the dryer 30. The sheet is moved by the rotation of pulleys in a direction opposite to the direction of movement in the process direction past the printheads. An actuator 40 operatively connected to pivot 88 is operated by the controller 80 to either block entry to the return path 72 and direct the media to the receptacle 56 or direct the media to the return path 72. At position 76, the substrates on the return path 72 can either be turned over so they can merge into the job stream being carried by the media transport 42 and the opposite side of the media sheet can be printed or left as they are so the printed side of the sheet can be printed again. To leave the sheets as they are, the controller 80 operates an actuator to turn pivot 82 counterclockwise to the position shown in the figure so the sheets bypass the bend in the return path and are directed to position 76 without being turned over. Thus, the printed side of the sheet can be printed. If the controller 80 operates the actuator to turn pivot 82 clockwise, then the sheet goes over the bend and is flipped before being returned to the transport path 42.

As further shown in FIG. 1, the printed media sheets S not diverted to the duplex path 72 are carried by the media transport to the sheet receptacle 56 in which they are be collected. Before the printed sheets reach the receptacle 56, they pass by an optical sensor 84B. The optical sensor 84B generates image data of the printed sheets and this image data is analyzed by the controller 80 to detect streakiness in the printed images on the media sheets of a print job. Additionally, sheets that are printed with test pattern images are printed at intervals during the print job. Image data of these test pattern images generated by optical sensor 84B are analyzed by the controller 80 to determine which inkjets, if any, that were operated to eject ink into the test pattern did in fact do so, and if an inkjet did eject an ink drop whether the drop landed at its intended position with an appropriate mass. Any inkjet not ejecting an ink drop it was supposed to eject or ejecting a drop not having the correct mass or landing at an errant position is called an inoperative inkjet in this document. The controller can store data identifying the inoperative inkjets in database 92 operatively connected to the controller 80. These sheets printed with the test patterns are sometimes called run-time missing inkjet (RTMJ) sheets and these sheets are discarded from the output of the print job. A user can operate the user interface 50 to obtain reports displayed on the interface that identify the number of inoperative inkjets and the printheads in which the inoperative inkjets are located. For sheets that are not inverted and merged into the job stream by the operation of pivoting member 86, optical sensor 84A generates image data of the printed side and the controller 80 uses that image data to register the sheets and to operate the ejectors in the printhead to further print images on the previously printed sheet sides. The optical sensors 84A and 84B can be a digital camera, an array of LEDs and photodetectors, or other devices configured to generate image data of a passing surface. While FIG. 1 shows the printed sheets as being collected in the sheet receptacle 56, they can be directed to other processing stations (not shown) that perform tasks such as folding, collating, binding, and stapling of the media sheets.

Operation and control of the various subsystems, components and functions of the machine or printer 10 are performed with the aid of a controller or electronic subsystem (ESS) 80. The ESS or controller 80 is operatively connected to the components of the printhead modules 36, 34A-34D (and thus the printheads), the detector 38, the actuators 40, and the image dryer 30. The ESS or controller 80, for example, is a self-contained computer having a central processor unit (CPU) with electronic data storage, and a display or user interface (UI) 50. The ESS or controller 80, for example, includes a sensor input and control circuit as well as a pixel placement and control circuit. In addition, the controller 80 reads, captures, prepares, and manages the image data flow between image input sources, such as a scanning system or an online or a work station connection (not shown), and the printhead modules 36 and 34A-34D. As such, the ESS or controller 80 is the main multi-tasking processor for operating and controlling all of the other machine subsystems and functions, including the printing process.

The controller 80 can be implemented with general or specialized programmable processors that execute programmed instructions. The instructions and data required to perform the programmed functions can be stored in non-transitory, computer readable medium associated with the processors or controllers. The processors, their memories, and interface circuitry configure the controllers to perform the operations described below when the programmed instructions are executed. These components can be provided on a printed circuit card or provided as a circuit in an application specific integrated circuit (ASIC). Each of the circuits can be implemented with a separate processor or multiple circuits can be implemented on the same processor. Alternatively, the circuits can be implemented with discrete components or circuits provided in very large scale integrated (VLSI) circuits. Also, the circuits described herein can be implemented with a combination of processors, ASICs, discrete components, or VLSI circuits.

In operation, image content data for an image to be produced are sent to the controller 80 from either a scanning system or an online or work station connection for processing and generation of the printhead control signals output to the printhead modules 36 and 34A-34D. Along with the image content data, the controller receives print job parameters that identify the media weight, media dimensions, print speed, media type, ink area coverage to be produced on each side of each sheet, location of the image to be produced on each side of each sheet, media color, media fiber orientation for fibrous media, print zone temperature and humidity, media moisture content, and media manufacturer. As used in this document, the term “print job parameters” means non-image content data for a print job and the term “image content data” means digital data that identifies an ink image to be printed on a media sheet.

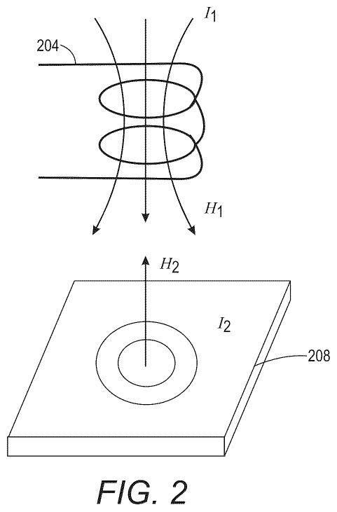

To detect and measure the primer applied to a media sheet, an inline non-contact sensor 38 is used. In one embodiment, the detector 38 is an eddy current sensor. As shown in FIG. 2, a high-frequency alternating current I1, that is, 1 MHz or higher is supplied to a coil 204 of fine wire to produce an alternating magnetic field H1 in the coil. In one embodiment, the wire is in a range of about 14-18 gauge±1 gauge. When the coil 204 is brought near a conductive material layer 208, the alternating magnetic field H1 produces eddy currents (I2) in the surface of the material layer. The characteristics of the material layer, such as conductivity, thickness, and the like, and the distance of the coil 204 from the conductive material layer 208 affect the magnitude of the eddy currents I2. The eddy currents I2 generate an opposing electromagnetic field H2 that can be sensed by the exciting coil 204 or by a second adjacent coil as a change in inductance or impedance. The depth of penetration (δ) of the eddy currents I2 into the material depends on the frequency of the alternating current in the coil 204 and the electrical conductivity of the material so that δ=1/(πfμσ)^{1/2}, where f is the frequency of the alternating current in the coil, μ is the magnetic permeability of the conductive material layer 208, and σ is the electrical conductivity of the conductive material layer 208. For thickness measurements, δ should be significantly greater than t, where t is the thickness of the conductive material layer. In one embodiment, δ is ten to twenty times the thickness t.

The primer solution typically consists of water (70%), glycerol (21%) and cations, such as Mg+, Ca+, or the like (9%). The high concentration of cations gives the primer an electrical conductivity than is higher than most aqueous inks by an order of magnitude. Consequently, measurement of eddy currents in a primer layer on a media sheet can be used to identify a thickness of the primer layer. For example, an exemplar primer has a conductivity of 2.2 Siemens/meter and a current penetration depth of 0.339 meters.

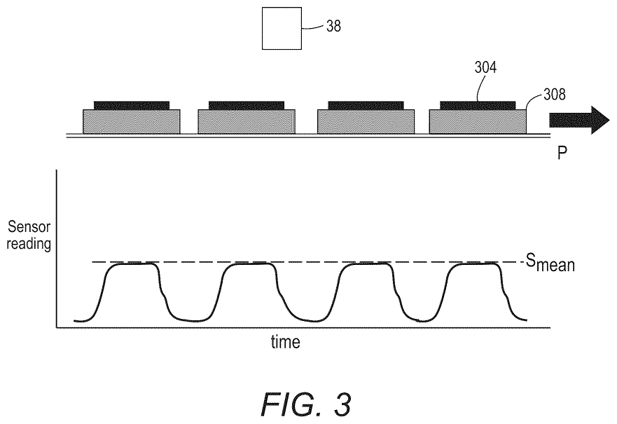

The primer detector outputs an electrical signal having a magnitude proportional to the eddy currents produced in the primer on a media substrate and a magnitude near zero when no primer is present. An example of this signal is shown in FIG. 3 for a series of media sheets 308 bearing primer 304 as the sheets past the detector 38 in the process direction P. This signal is provided to the controller 80 and used by the controller to regulate the operation of ejectors in the printheads of module 36 to eject drops of primer onto the media sheets. Regulation of the ejectors can be achieved by altering a firing signal parameter such as the magnitude of the firing signals provided to the ejectors or the like.

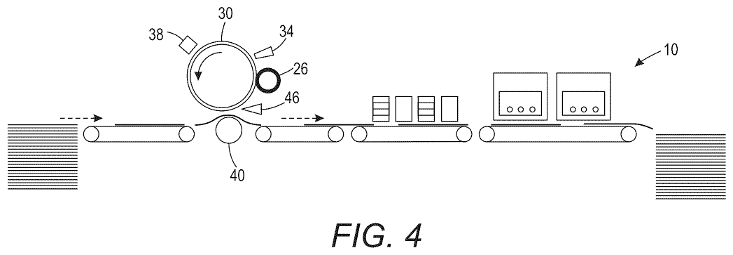

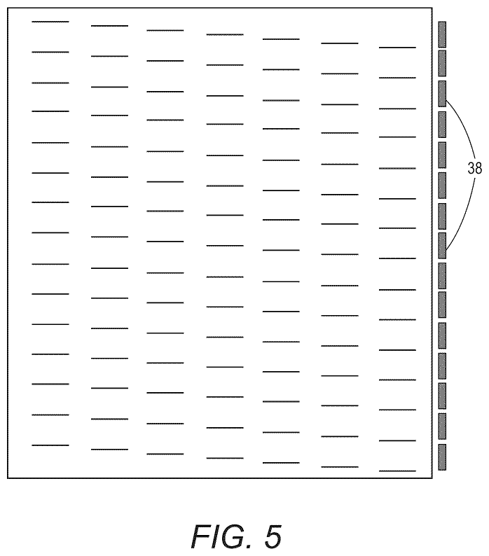

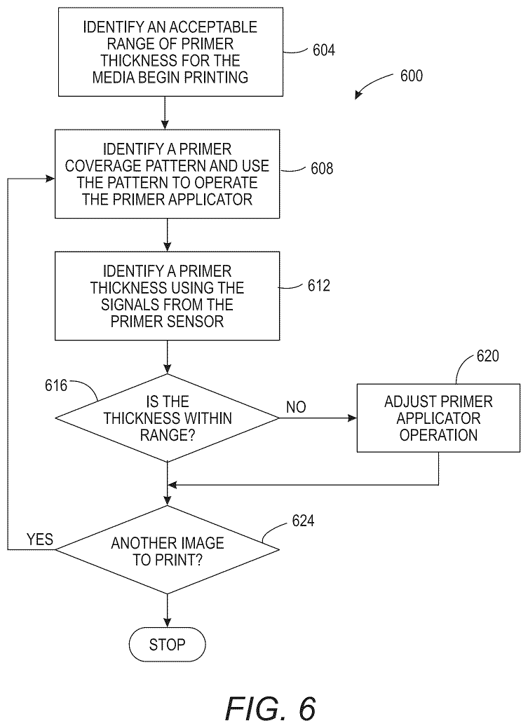

In some embodiments, the primer applicator can be an anilox roller to which primer has been applied by another roller partially submerged in a receptacle containing primer or that contains a reservoir of primer internally stored in the roller. In these embodiments, the operation of the actuator pressing the roller against the media sheets is adjusted to reduce or increase the pressure of the roller against the sheets. The target value thickness used for regulation of the primer applicator is within a range of acceptable primer thicknesses. The controller is configured to identify the end points of this range. In one embodiment, the range extends between a primer thickness that is too thin to enable deinking of the printed media and a primer thickness that is too thick for sufficient ink drying within the image dryer to fix the ink image to the media. These thicknesses are a function of paper type, such as coated or uncoated media, the weight of the media in grams/m², and the like. The results obtained with changed operational parameters for the primer applicator can be verified using ink spread measurements obtained from image data generated by the optical sensor 84B of printed media. For example, the printer 10 shown in FIG. 4 applies primer to intermediate roller 30 with a roller 26 as described above. The primer is dried with dryer 34. Non-contact eddy current sensor 38 is positioned to measure the thickness of the primer on the roller 30 before it is transferred to media in the nip 46 between roller 30 and transfer roller 40 so the application of the primer to the roller 30 can be regulated. In some embodiments, roller 30 is an intermediate belt that is configured about pulleys within the interior of the belt.

Eddy current sensors 38 can be configured for identifying inoperative inkjets in the module 36. As shown in FIG. 5, an array of sensors is placed inboard to outboard in the cross-direction over the media transport. The number and arrangement of the sensors 38 is configured with reference to the field of view (FOV) of the sensors f. This parameter f is typically a few millimeters but can be adjusted by varying the gap between the sensors and the media. The sensors are placed at intervals of ±f/2 in the cross-process direction of the media. The controller uses a test pattern of dashes to operate the primer applicator to produce a test pattern of primer dashes on media as shown in the figure. Measurements of the eddy currents produced by the dashes as they pass a sensor 38 are compared to a threshold by the controller 80. The measurements within the field of view of the sensor that are greater than a predetermined threshold indicate the presence of a dash. The predetermined threshold corresponds to an eddy current measurement that a complete dash produces as it passes through the field of view of a sensor. These measurements are used to form a map of the media sheet showing where dashes were detected. This map is compared to the primer pattern used to operate the ejectors in the module 36. By identifying the areas where primer is expected but none is detected, inoperative ejectors can be identified. Thus, the dash pattern is designed to allow each dash to correspond to a unique ejector so inoperative ejectors can be detected reliably by exactly one sensor. Known compensation techniques can be used to enable the module 36 to continue to be used for applying primer to the media sheets until the failure rate of the ejectors exceeds a predetermined threshold.

A process 600 for operating the inkjet printer of FIG. 1 to apply primer to media sheets efficiently is shown in FIG. 6. In the description of the process, statements that the process is performing some task or function refers to a controller or general purpose processor executing programmed instructions stored in non-transitory computer readable medium operatively connected to the controller or processor to manipulate data or to operate one or more components in the printer to perform the task or function. The controller 80 noted above can be such a controller or processor. Alternatively, the controller can be implemented with more than one processor and associated circuitry and components, each of which is configured to perform one or more tasks or functions described herein. Additionally, the steps of the method may be performed in any feasible chronological order, regardless of the order shown in the figures or the order in which the processing is described.

The process 600 of FIG. 6 begins by identifying a range of acceptable primer thicknesses using the media type identified in the print job parameters (block 604). As the print job commences, the ink coverage pattern for each ink image is identified using the image content data and this pattern is used to operate the ejectors in the primer application module (block 608). As the primer image passes the primer sensor(s), the signals are used to measure a thickness of the primer on the media sheet (block 612) and the measured thickness is compared to the range of acceptable primer thicknesses (block 616). If the primer thickness is out of range, the operation of the primer application module is adjusted (block 620). This process continues for each image in the print job (block 624) until there are no more images to print. If an anilox roller is used to apply primer directly to the belt, then the processing of block 608 is not performed.

It will be appreciated that variants of the above-disclosed and other features, and functions, or alternatives thereof, may be desirably combined into many other different systems or applications. Various presently unforeseen or unanticipated alternatives, modifications, variations, or improvements therein may be subsequently made by those skilled in the art, which are also intended to be encompassed by the following claims.

What is claimed is:

1. An inkjet printer comprising:
a primer applicator configured to apply primer to media as the media passes the primer applicator;
a sensor configured to generate electrical signals corresponding to a thickness of the primer applied to the media; and
a controller operatively connected to the primer applicator and the sensor, the controller being configured to:
identify a range of primer thicknesses for the media to which the primer is being applied;
identify a thickness of the primer on the media;
compare the identified thickness to the identified range of primer thicknesses; and
adjust operation of the primer applicator in response to the identified thickness being out of the identified range of primer thicknesses.

2. The inkjet printer of claim 1 wherein the primer applicator is a roller.

3. The inkjet printer of claim 1 wherein the primer applicator is a printhead having a plurality of ejectors configured to eject drops of primer onto the media.

4. The inkjet printer of claim 3 wherein the sensor is a eddy current sensor.

5. The inkjet printer of claim 4, the controller being further configured to:
identify a first end of the range of primer thicknesses as a thickness that is too thin to enable deinking of the media; and
identify a second end of the range of primer thicknesses as a thickness that is too thick for sufficient ink drying within an image dryer in the inkjet printer to fix an ink image to the media.

6. The inkjet printer of claim 5, the controller being further configured to:
adjust operation of the primer applicator by altering a firing signal parameter for the primer applicator.

7. The inkjet printer of claim 6 wherein the firing signal parameter is a firing signal magnitude.

8. The inkjet printer of claim 7 further comprising:
a plurality of eddy current sensors arranged in a cross-process direction of a path for the media through the inkjet printer; and the controller being further configured to:
operate the primer applicator using a test pattern to eject drops of primer on the media passing the primer applicator;
generate a map of positions of primer drops on the media;
compare the positions of the primer drops on the media to the test pattern used to operate the primer applicator; and
identify an ejector in the primer applicator as inoperative in response to a position in the test pattern not having a corresponding position for a primer drop in the generated map.

9. The inkjet printer of claim 8 wherein the eddy current sensors are separated in the cross-process direction by one-half a field of view of the eddy current sensors.

10. The inkjet printer of claim 9 wherein the test pattern is a plurality of dashes.

11. A method of operating an inkjet printer comprising:
identifying a range of primer thicknesses for media to which a primer is to be applied by a primer applicator;
identifying a thickness of primer applied to the media;
comparing the identified thickness to the identified range of primer thicknesses; and
adjusting operation of the primer applicator in response to the identified thickness being out of the identified range of primer thicknesses.

12. The method of claim 11 wherein the primer applicator is a roller.

13. The method of claim 11 wherein the primer applicator is a printhead having a plurality of ejectors configured to eject drops of primer onto the media.

14. The method of claim 13, the identification of the thickness of the primer further comprising:
generating electrical signals corresponding to a thickness of the primer applied to the media; and
identifying a thickness of the primer on the media using the generated electrical signals.

15. The method of claim 14 further comprising:
identifying a first end of the range of primer thicknesses as a thickness that is too thin to enable deinking of the media; and
identifying a second end of the range of primer thicknesses as a thickness that is too thick for sufficient ink drying within an image dryer in the inkjet printer to fix an ink image to the media.

16. The method of claim 15 further comprising:
adjusting operation of the primer applicator by altering a firing signal parameter for the primer applicator.

17. The method of claim 16 wherein the firing signal parameter is a firing signal magnitude.

18. The method of claim 17 further comprising:
operating the primer applicator using a test pattern to eject drops of primer on the media passing the primer applicator;
generating a map of positions of primer drops on the media;
comparing the positions of the primer drops on the media to the test pattern used to operate the primer applicator; and
identifying an ejector in the primer applicator as inoperative in response to a position in the test pattern not having a corresponding position for a primer drop in the generated map.

19. The method of claim 18, the generation of the map further comprising:
identifying the positions in the map using signals from eddy current sensors arranged in a cross-process direction across a path of the media.

20. The method of claim 19 wherein the eddy current sensors are separated in the cross-process direction by one-half a field of view of the eddy current sensors.
